(19) United States
(12) Patent Application Publication
(10) Pub. No.: US 2013/0173170 A1
(43) Pub. Date: Jul. 4, 2013

(54) WEB-BASED PLATFORM FOR ANALYZING LARGE-SCALE TOF-SIMS DATA AND METHOD THEREOF

(71) Applicants: Tae Geol LEE, Yoseong-gu (KR); Dae Hee Hwang, Pohang-si (KR); So Jeong Yun, Pohang-si (KR); Ji Won Park, Yuseong-gu (KR)

(72) Inventors: Tae Geol LEE, Yoseong-gu (KR); Dae Hee Hwang, Pohang-si (KR); So Jeong Yun, Pohang-si (KR); Ji Won Park, Yuseong-gu (KR)

(21) Appl. No.: 13/405,147

(22) Filed: Feb. 24, 2012

(30) Foreign Application Priority Data
Dec. 28, 2011 (KR) 10-2011-0144694

(51) Int. Cl. G06F 19/10

(52) U.S. Cl. 702/19

(57) ABSTRACT

Disclosed is a web-based platform for analyzing large-scale TOF-SIMS data and a method thereof. The web-based platform for analyzing large-scale TOF-SIMS data according to the present invention comprises: a communication unit for providing a connected user terminal with a web page and receiving a file for analyzing the TOF-SIMS data from the user terminal via the provided web page; a processing unit for analyzing the TOF-SIMS data using the received file and providing the user terminal with information created based on a result of the analysis via the communication unit; and a storage unit for storing the information created based on the result of the analysis. Through the platform, the present invention may provide a web-based tool that can be used in an automated analysis method.

### CROSS-REFERENCE

This application claims the benefit of priority to Korean Patent Application No. 10-2011-0144694, filed on Dec. 28, 2011, the contents of which are incorporated by reference herein in its entirety.

### BACKGROUND OF THE INVENTION

1. Field of the Invention

The present invention relates to TOF-SIMS, and particularly, to a web-based platform for analyzing large-scale TOF-SIMS data and a method thereof, which automatically perform identification of peaks, alignment of peaks, detection of discriminatory ions, building of classifiers, and construction of networks describing differential metabolic pathways.

2. Background of the Related Art

Time-of-flight secondary ion mass spectrometry (TOF-SIMS) is useful for analyzing chemical composition and distribution of positive (+) and negative (−) secondary ions from the very near surface region of specimens through high molecular specificity, high surface sensitivity, and submicron spatial resolution. Recently, TOF-SIMS is successfully applied to complex biological samples, such as cells and tissues. As a result, studies on TOF-SIMS spectra which represent surface chemical characteristics of the biological samples are under progress.

As TOF-SIMS is applied to clinical tissue samples recently, an enormous amount of TOF-SIMS data is obtained. A TOF-SIMS spectrum obtained from a tissue generally contains hundreds or even thousands of ion peaks. The enormous amount of ion peaks contained in the TOF-SIMS spectrum should be identified and compared. However, tools suitable for automatically analyzing a large amount of high-dimensional data are insufficient.

Several tools are introduced to analyze the TOF-SIMS data. IonSpec and TOFPak, for example, are used to identify ion peaks from a spectrum first. Second, peaks identified from different samples should be combined in order to compare and analyze a plurality of ions contained in multiple samples, and this is called peak alignment. The peak alignment is manually performed, and thus it could be difficult to process samples of a large size. Next, multivariate statistical analyses (MVAs), such as principal component analysis (PCA) and partial least squares (PLS), are used to select ions identifiable among samples of different groups and visualize the samples. They are reported to be appropriate for analyzing complex data generated from various biological specimens such as proteins, cells, and tissues. Finally, discriminatory ions selected by the MVAs are generally identified by matching their masses to those of known metabolites using commercial or public databases. However, such a database search can be complicated by multiple matches of single ions since mass tolerance is considerably large in TOF-SIMS. Furthermore, typically, all of these analyses are performed manually without an available automation tool.

### SUMMARY OF THE INVENTION

Therefore, the present invention has been made in view of the above problems, and it is an object of the present invention to provide a web-based platform for analyzing large-scale TOF-SIMS data and a method thereof, which automatically perform identification of peaks, alignment of peaks, detection of discriminatory ions, building of classifiers, and construction of networks describing differential metabolic pathways.

However, the objects of the present invention are not limited to those mentioned above, and unmentioned other objects will become apparent to those skilled in the art from the following descriptions.

To accomplish the above objects, according to one aspect of the present invention, there is provided a web-based platform for analyzing large-scale TOF-SIMS data, the platform comprising: a communication unit for providing a connected user terminal with a web page and receiving a file for analyzing the TOF-SIMS data from the user terminal via the provided web page; a processing unit for analyzing the TOF-SIMS data using the received file and providing the user terminal with information created based on a result of the analysis via the communication unit; and a storage unit for storing the information created based on the result of the analysis.

Preferably, the file includes at least any one of an IonSpec result file containing a peak list and a raw spectra file containing positive and negative spectra.

Preferably, the processing unit may analyze the TOF-SIMS data using the IonSpec result file and the raw spectra file.

Preferably, the processing unit may create at least one of an alignment table, a discriminatory peak summary table, a PLS-DA model, a cross-validation of the model, identification of discriminatory ions, and a result of pathway analysis of the discriminatory ions, as a result of the analysis.

Preferably, metabolic ions for 66 discriminatory peaks searched from a gastric cancer are identified by a search in a HMDB using an m/z value having a mass tolerance of 0.1 Da.

33 m/z pairs shown in the following table may be used for the metabolic ions for the 66 discriminatory peaks searched from the gastric cancer.

| | | Up/Down- | | | |
|---|---|---|---|---|---|
| | | Regulation | Chemical | | |
| Polarity | m/z | in cancer | formula | Adduct | Compound |
| Positive | 113.00 | Up | C3H6O2 | M+K [1+] | Hydroxyacetone |
| ion | | | C3H6O2 | M+K [1+] | L-Lactaldehyde |
| | | | C3H6O2 | M+K [1+] | Propanoate |
| | | | C3H6O2 | M+K [1+] | D-Lactaldehyde |
| | | | C3H6O2 | M+K [1+] | 3-Hydroxypropanal |
| | 115.05 | Up | C4H6N2O2 | M+H [1+] | Dihydrouracil |
| | | | C4H6N2O2 | M+H [1+] | N-Methylhydantoin |
| | 118.07 | Up | C8H7N | M+H [1+] | Indole |
| | 112.10 | Up | C8H11N | M+H [1+] | Phenylethyamine |
| | 127.04 | Up | C4H8O3 | M+Na [1+] | (R)-3-Hydroxybutanoate |
| | | | C4H8O3 | M+Na [1+] | 4-Hydroxybutanoate |
| | | | C4H8O3 | M+Na [1+] | 2-Hydroxybutyrate |
| | | | C5H6N2O2 | M+H [1+] | Imidazole-4-acetate |
| | | | C5H6N2O2 | M+H [1+] | Thymine |
| | 132.06 | Up | C5H9NO3 | M+H [1+] | trans-4-Hydroxy-L-proline |
| | | | C5H9NO3 | M+H [1+] | L-Glutamate-5- |
| | | | | | semialdehyde |
| | | | C5H9NO3 | M+H [1+] | 2-Oxo-5-aminovalerate |
| | | | C5H9NO3 | M+H [1+] | 5-Aminolevulinate |
| | 133.10 | Up | C5H12N2O2 | M+H [1+] | L-Ornithine |
| | | | C5H12N2O2 | M+H [1+] | D-Ornithine |
| | 139.04 | Up | C5H8O3 | M+Na [1+] | 3-Methyl-2-oxobutannoate |
| | | | C7H6O3 | M+H [1+] | Gentisate aldehyde |
| | | | C7H6O3 | M+H [1+] | Salicylate |
| | | | C7H6O3 | M+H [1+] | 4-Hydroxybenzonate |
| | | | C6H6N2O2 | M+H [1+] | Urocanate |
| | 144.08 | Up | C8H11N | M+Na [1+] | Phenylethylamine |
| | 146.10 | Up | C5H11N3O2 | M+H [1+] | 4-Guanidinobutanoate |
| | 147.11 | Up | C6H14N2O2 | M+H [1+] | L-Lysine |
| | 153.04 | Up | C5H4N4O2 | M+H [1+] | Xanthine |
| | 178.05 | Up | C6H11NO3S | M+H [1+] | N-Formyl-L-methionine |
| Negative | 59.02 | Down | CH4N2O | M−H [1−] | Urea |
| ion | 125.05 | Down | C5H6N4O | M−H [1−] | AlCAR |
| | | | C4H12N2 | M+k−2H [1−] | Putrescine |

Preferably, 25 discriminatory peaks among the 66 discriminatory peaks are assigned to 73 metabolites by the database search.

Preferably, the processing unit may provide the user terminal with the information created based on the result of the analysis via the web page.

Preferably, the processing unit provides the user terminal with the information created based on the result of the analysis via a message or an e-mail, and the message or the e-mail contains a link to an analysis result page.

According to another aspect of the present invention, there is provided a method of analyzing large-scale TOF-SIMS data, the method comprising the steps of: (a) providing a connected user terminal with a web page and receiving a file for analyzing the TOF-SIMS data from the user terminal via the provided web page; (b) analyzing the TOF-SIMS data using the received file; and (c) providing the user terminal with information created based on a result of the analysis.

Preferably, the file includes at least any one of an IonSpec result file containing a peak list and a raw spectra file containing positive and negative spectra.

Preferably, step (b) may analyze the TOF-SIMS data using the IonSpec result file and the raw spectra file.

Preferably, step (c) may create at least one of an alignment table, a discriminatory peak summary table, a PLS-DA model, a cross-validation of the model, identification of discriminatory ions, and a result of pathway analysis of the discriminatory ions, as a result of the analysis.

Preferably, metabolic ions for 66 discriminatory peaks searched from a gastric cancer are identified by a search in a HMDB using an m/z value having a mass tolerance of 0.1 Da.

Preferably, 25 discriminatory peaks among the 66 discriminatory peaks are assigned to 73 metabolites by the database search.

Preferably, step (c) may provide the user terminal with the information created based on the result of the analysis via the web page.

Preferably, step (c) may provide the user terminal with the information created based on the result of the analysis via a message or an e-mail, and the message or the e-mail may contain a link to an analysis result page.

Through the web-based platform for analyzing large-scale TOF-SIMS data and a method thereof, the present invention automatically performs identification of peaks, alignment of peaks, detection of discriminatory ions, building of classifiers, and construction of networks describing differential metabolic pathways and thus provides a web-based tool that can be used in an automated analysis method.

### BRIEF DESCRIPTION OF THE DRAWINGS

FIG. 1 is a view showing a web-based platform for analyzing large-scale TOF-SIMS data according to an embodiment of the present invention.

FIG. 2 is a view showing a sample index file according to an embodiment of the present invention.

FIG. 3 is a view showing an IonSpec result file according to an embodiment of the present invention.

FIG. 4 is a view showing a raw spectra file according to an embodiment of the present invention.

FIG. 5 is a view illustrating a process of uploading an input file according to an embodiment of the present invention.

FIG. 6 is a view showing a data analysis page according to an embodiment of the present invention.

FIG. 7 is a view showing a result section of an alignment table according to an embodiment of the present invention.

FIG. 8 is a view showing a result section of an alignment assessment according to an embodiment of the present invention.

FIG. 9 is a view showing a result section of discriminatory ion peaks according to an embodiment of the present invention.

FIG. 10 is a view showing a result section of a PLS-DA model according to an embodiment of the present invention.

FIG. 11 is a view showing a result section of cross validation of a model according to an embodiment of the present invention.

FIG. 12 is a view showing a result section of identification of discriminatory ions according to an embodiment of the present invention.

FIG. 13 is a view showing a result section of pathway analysis of discriminatory ions according to an embodiment of the present invention.

FIG. 14 is a view showing a TOF-SIMS analysis according to an embodiment of the present invention.

FIG. 15 is a view showing peak identification and improvement according to an embodiment of the present invention.

FIG. 16 is a view showing peak alignment according to an embodiment of the present invention.

FIG. 17 is a view showing integrative selection of discriminatory ions according to an embodiment of the present invention.

FIG. 18 is a view showing determination of the number of PLS-LVs according to an embodiment of the present invention.

FIG. 19 is a view showing discriminatory peaks and pathways according to an embodiment of the present invention.

FIG. 20 is a view showing a network according to an embodiment of the present invention.

### DESCRIPTION OF SYMBOLS

110: Communication unit
120: Processing unit
130: Storage unit

### DETAILED DESCRIPTION OF THE PREFERRED EMBODIMENT

The web-based platform for analyzing large-scale TOF-SIMS data and a method thereof according to embodiments of the invention will be hereafter described in detail, with reference to the accompanying drawings. In the drawings illustrating the embodiments of the invention, elements having like functions will be denoted by like reference numerals and details thereon will not be repeated. In addition, if already known functions or specific description of constitution related to the present invention may make the spirit of the present invention unclear, detailed description thereof will be omitted.

Particularly, the present invention proposes a framework or a web-based platform for effectively analyzing TOF-SIMS data, which automatically performs identification of peaks, alignment of peaks, detection of discriminatory ions, building of classifiers, and construction of networks describing differential metabolic pathways.

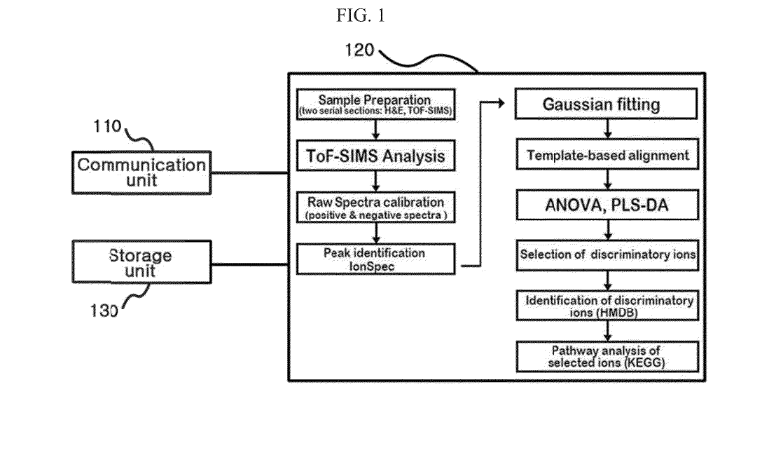

FIG. 1 is a view showing a web-based platform for analyzing large-scale TOF-SIMS data according to an embodiment of the present invention.

As shown in FIG. 1, the web-based platform (TOFSIMS-P) for analyzing large-scale TOF-SIMS data according to the present invention refers to a web-based tool that can perform (i) identification of peaks, (ii) alignment of peaks, (iii) detection of discriminatory ions, (iv) building of classifiers, (v) and construction of networks describing differential metabolic pathways.

The TOFSIMS-P may include a communication unit 110, a processing unit 120, and a storage unit 130.

The communication unit 110 may perform wired or wireless communication with a user terminal to transmit and receive a variety of data. That is, the communication unit 110 may provide the user terminal with a web page and receive an IonSpec result file and a raw spectra file as files for analyzing the TOF-SIMS data from the user terminal through the provided web page. In addition, the communication unit 110 may provide the user terminal with a result of analysis performed using the received IonSpec result file and raw spectra file through the web page.

In addition, the communication unit 110 may provide the user terminal with the result of analysis through a message or an e-mail. If the user terminal receives the e-mail containing a link to an analysis result page, it may connect to the analysis result page by clicking the link and browse the result of the analysis.

The processing unit 120 may analyze the TOF-SIMS data using the IonSpec result file and the raw spectra file. That is, the processing unit 120 may create an alignment table, a discriminatory peak summary table, a PLS-DA model generated based on discriminatory peaks, cross-validation of the model, identifications of discriminatory ions, and a result of pathway analysis of discriminatory ions, as a result of the analysis.

The storage unit 130 may store a result of alignment assessment, the discriminatory peak summary table, the PLS-DA model, the cross-validation of the model, the identifications of discriminatory ions, and the result of pathway analysis of discriminatory ions.

In order to resolve the conventional problems and automate the analysis procedure, based on the TOFSIMS-P according to the present invention configured as described above, a computerized framework for effectively analyzing the TOF-SIMS data is developed, which can perform identification of peaks, alignment of peaks, detection of discriminatory ions, building of classifiers, and construction of networks describing differential metabolic pathways. To show validity of the tool, analyzed are 43 datasets generated from seven gastric cancer tissue samples and eight normal tissue samples using TOF-SIMS. A total of 87,138 ions are detected, and 1,286 ions are selected and aligned using a template-based method. Then, 66 ions for discriminating gastric cancer tissues are selected for normal controls based on ANOVA and PLS-DA. Using the 66 ions, a PLS-DA model is built based on the results of a low misclassification error rate from the cross-validation. Finally, a network model is reconstructed using the 66 ions. The network reveals disregulation of metabolism of amino acids, such as arginine, proline, and phenylalanine, in the gastric cancers. The results support that the proposed tool effectively analyzes TOF-SIMS data of samples of a considerably large size.

The analysis procedure of the TOF-SIMS-P for analyzing large-scale TOF-SIMS data will be described below.

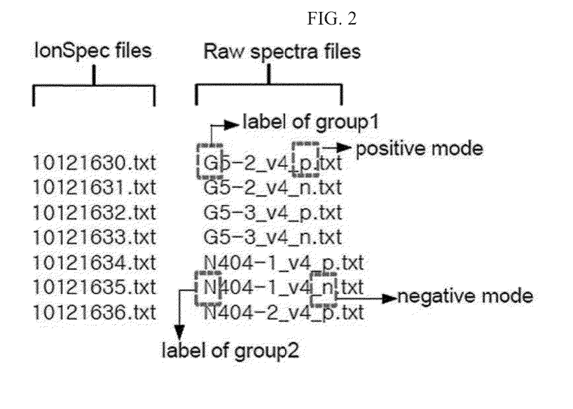

FIG. 2 is a view showing a sample index file according to an embodiment of the present invention.

As shown in FIG. 2, a sample index file “Index.txt” has two columns including names of IonSpec result files and names of corresponding raw spectra files. A name of a raw spectra file has first and last letters respectively representing a group of a sample, i.e., A, B, . . . , or Z, and an ion mode of two types, i.e., positive or negative.

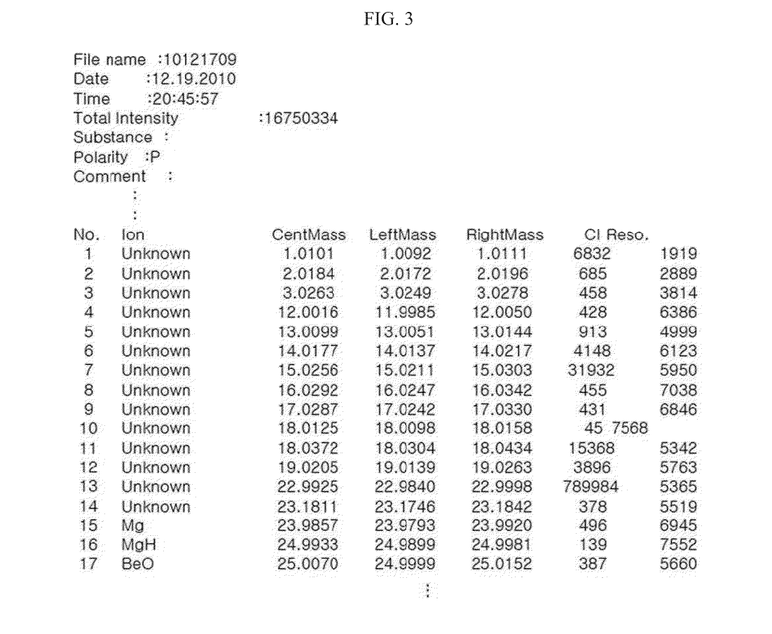

FIG. 3 is a view showing an IonSpec result file according to an embodiment of the present invention.

As shown in FIG. 3, configuration options of a peak list menu of the IonSpec are set as follows in order to generate a format of a result file. 1) Click on a check box of the options: Index Number, Substance, CentMass, LowerMass, UpperMass, Correct Intensity, and Resolution; 2) Save the peak list as an ASCII file having a peak configuration using macro function ‘SaveSpecASCII’ of TOFBAT.

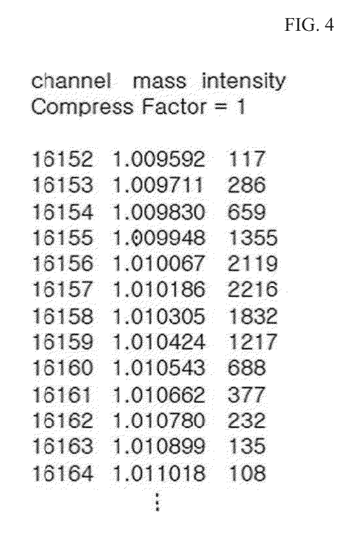

FIG. 4 is a view showing a raw spectra file according to an embodiment of the present invention.

As shown in FIG. 4, the export option of “Save As ASCII TXT file” should be set as “Compression Factor=1” in order to generate the format of the raw spectra files.

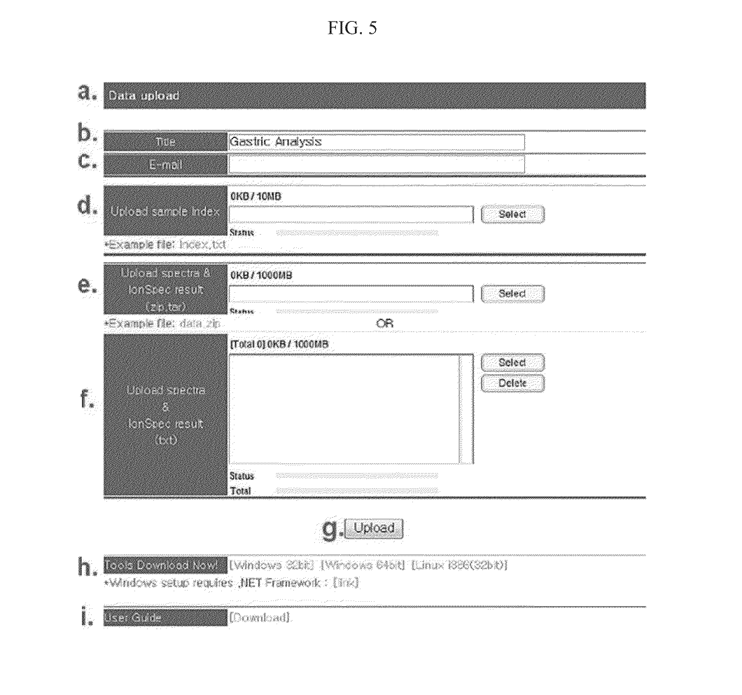

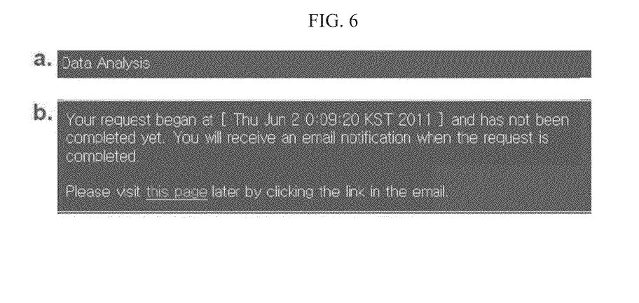

FIG. 5 is a view illustrating a process of uploading an input file according to an embodiment of the present invention.

As shown in FIG. 5, fields in the main page are checked and filled with input files. Hereinafter, functions of the plurality of field in the main page will be described.

A. Data upload: Shows a status in the blue bar on the top of the main page.

B. Title: Type in a job title.

C. E-mail: Type in an e-mail address of a user who can receive an analysis progress message.

D. Upload the sample index file: Upload a file containing a list of file names.

E. Upload spectra & IonSpec results: Upload a zip file containing a raw spectra file and an IonSpec result file.

F. Upload spectra & IonSpec result: Upload a raw spectra file and an IonSpec result file.

A user should select an option of either E or F.

G. Implement upload: After uploading a sample index, a spectra file and an IonSpec result file, click the “upload” button.

H. Tools download now: The user may download a code to be used in TOFSIMS-P. The code can be used in both Windows and Linux. Windows users should install “.NET Framework” that can be used in the main page.

I. User Guide: “User guide” can be used for download.

By clicking the “Upload” button, the page will show information on the progress of analysis as shown in FIG. 6.

FIG. 6 is a view showing a data analysis page according to an embodiment of the present invention.

As shown in FIG. 6, after the analysis is completed, the user will receive an email including a link to the analysis result page. By clicking the link, the user may connect to the result page and browse the analysis result. This will be described below in detail.

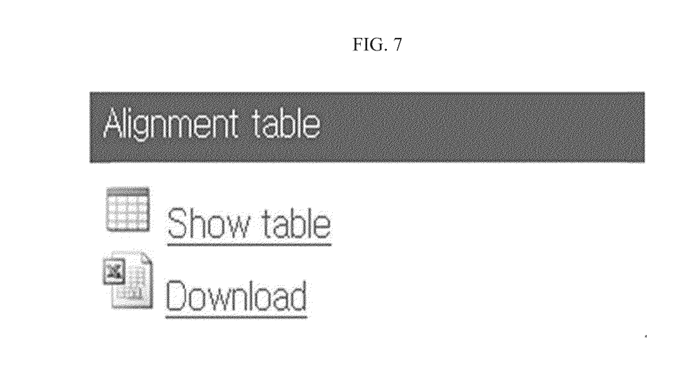

FIG. 7 is a view showing a result section of an alignment table according to an embodiment of the present invention.

As shown in FIG. 7, an alignment table can be shown in a pop-up window by clicking “Show table” and then can be downloaded by clicking “Download”. The alignment table includes m/z of peaks, m/z ranges, and peak intensities.

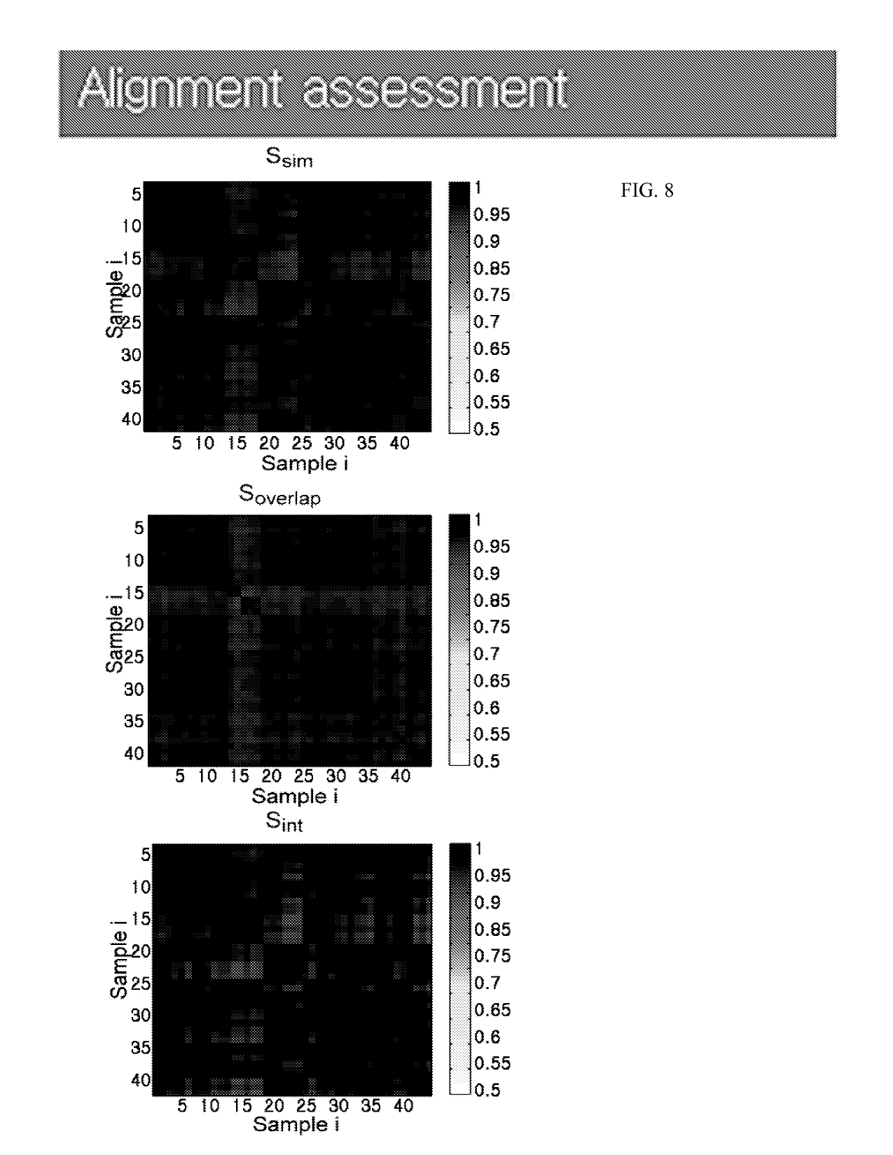

FIG. 8 is a view showing a result section of an alignment assessment according to an embodiment of the present invention.

As shown in FIG. 8, TOFSIMS-P assesses performance of alignment by evaluating similarities of all possible pairs of samples. For each pair of samples, TOFSIMS-P evaluates the number of peaks detected in the two samples (Sₒᵥₑᵣₗₐₚ), correlation of peak intensities (Sᵢₙₜ), and their product as a combined similarity measure (Sₛᵢₘ). A high similarity score indicates that the peaks in different samples are successfully aligned, considering that a majority of the peaks are not likely to be changed in their abundances across the samples. The elements of matrixes Sₒᵥₑᵣₗₐₚ, Sᵢₙₜ, and Sₛᵢₘ show the similarities in samples i and j. Click to enlarge the figures.

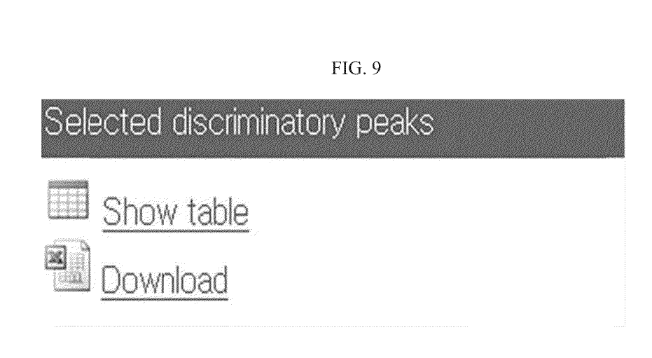

FIG. 9 is a view showing a result section of discriminatory ion peaks according to an embodiment of the present invention.

As shown in FIG. 9, a summary table of discriminatory peaks can be shown in a pop-up window by clicking “Show table” and then can be downloaded by clicking “summary.csv”. The summary table may include the followings.

1st column: m/z of peak

2nd column: mean of variable importance in projection(VIP) for 1000 times the 10-fold cross-validation

3rd column: types of ion modes (positive mode: 1, negative mode: 0)

4th column: types of regulation (up-regulated in cancer: 1, downregulated in normal: 0)

5th column: fold change in log 2scale (foldchange>0: up-regulated in cancer, fold change<0: down-regulated in cancer)

6th column: p-value from ANOVA

7th column: normalized peak intensity for each sample

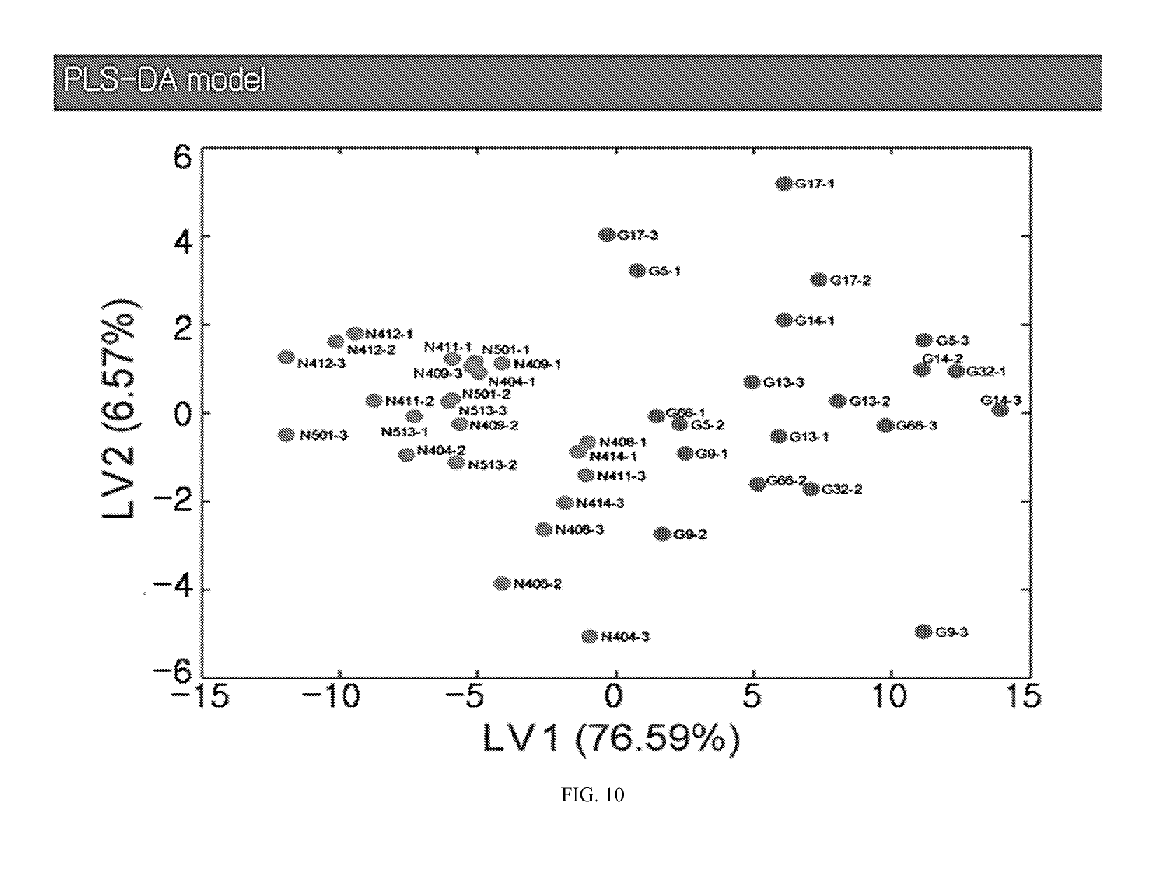

FIG. 10 is a view showing a result section of a PLS-DA model according to an embodiment of the present invention.

As shown in FIG. 10, TOFSIMS-P shows a PLS-DA model constructed based on discriminatory peaks. Click to enlarge the figure. X- and y-axes represent the 1^{st} and 2^{nd} latent variable (LVs). Explained variances of LVs are shown in the brackets.

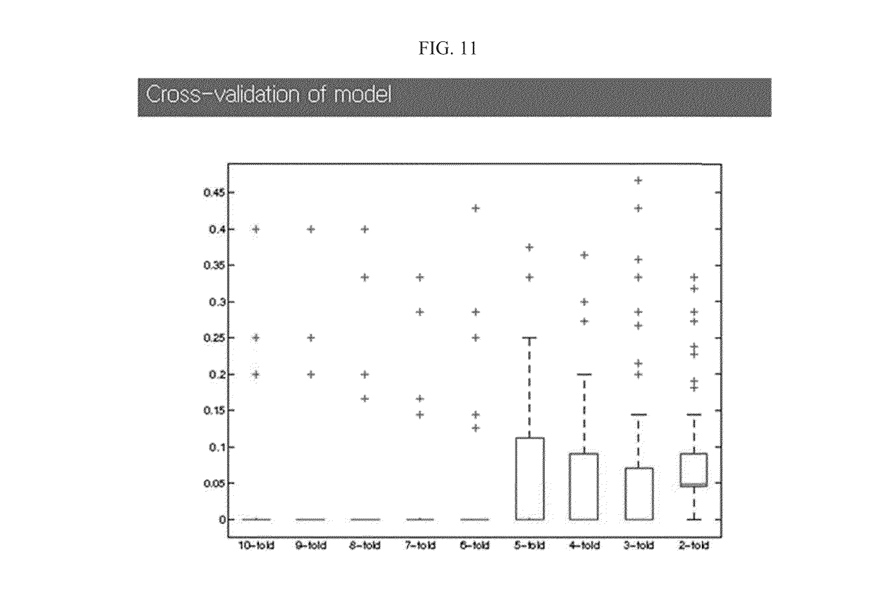

FIG. 11 is a view showing a result section of cross validation of a model according to an embodiment of the present invention.

As shown in FIG. 11, TOFSIMS-P evaluates robustness in the performance of PLS-DA using discriminatory peaks against variation in the size of a training set by performing incremental-fold cross-validations (CVs). Click to enlarge the figure. X- and y-axes represent folds of CV and misclassification error rates, respectively.

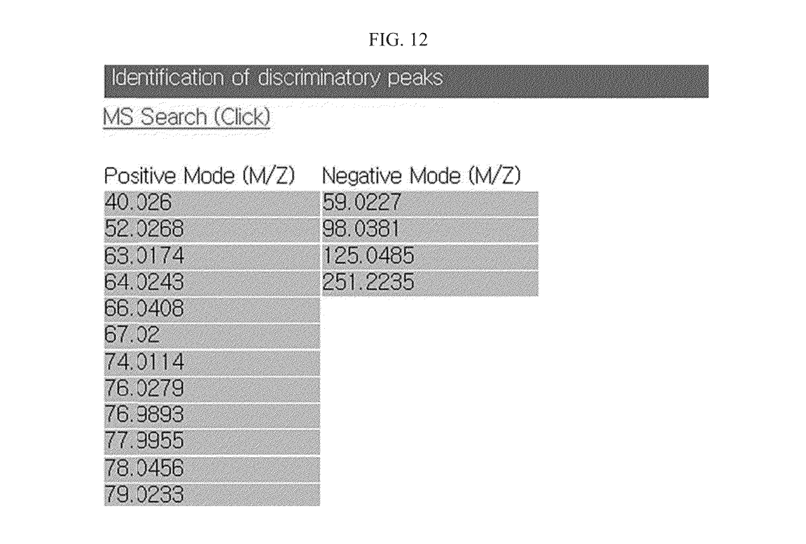

FIG. 12 is a view showing a result section of identification of discriminatory ions according to an embodiment of the present invention.

As shown in FIG. 12, the list of discriminatory peaks in this page can be classified by ion modes. The page provides a link to a Human Metabolome Database (HMDB) for identifying discriminatory links. By clicking “MS Search”, the HMDB page will be shown in a pop-up window. In this page, the user should first define “molecular Species”, positive or negative, paste the list of m/z of discriminatory peaks to section “MV” depending on molecular species, and set “MW Tolerance”. Clicking “Find Metabolites” will initialize the search, and a search result can be downloaded as a “*.xls” file.

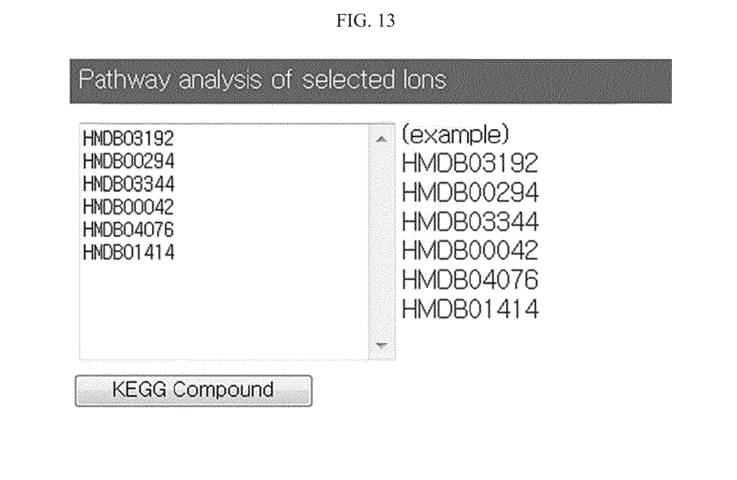

FIG. 13 is a view showing a result section of pathway analysis of discriminatory ions according to an embodiment of the present invention.

As shown in FIG. 13, TOFSIMS-P provides a link to a KEGG compound for analyzing pathways of selected ions. The list of HMDB IDs of the selected ions is pasted to the field marked by a dashed line, and then click “KEGG compound” to generate KEGG compound IDs. Clicking “Pathway mapping” will show a lot of pathways by the selected ions. By clicking each pathway, the selected ions involved in the pathway will be shown.

Hereinafter, an analysis method of TOFSIMS-P according to the present invention will be described in detail.

1. Sample Preparation

Tissues are obtained from the National Cancer Center in Korea between 2005 and 2008, with informed consent and approval of the institutional review board. Samples are frozen in liquid nitrogen and stored at −80° C. until the analysis is performed. No chemical fixation is done because of the possibility of chemical fixatives which react with the molecules detected by TOF-SIMS. Two sections of the tissues are made to have a thickness of 10 μm at a temperature of −20° C. using a cryomicrotome. One section is affixed to a slide glass and stained with hematoxylin and eosin (H&E). The tissue is diagnosed via an image of an optical microscope. The other section is deposited onto a Si wafer rinsed with ethanol and acetone for 5 minutes, respectively, and directly analyzed by TOF-SIMS.

2. TOF-SIMS Analysis

TOFSIMS-P may perform ion profiling on normal and tumor tissues using a TOF-SIMS V instrument equipped with a bismuth liquid metal ion gun (LMIG). Bi³⁺ primary ions are used to obtain positive and negative spectra at 25 keV in the high-current bunched mode. An analysis area of 100×100 μm² is randomly rastered by the primary ions with a spatial resolution of 1 μm and charge-compensated for tissue samples by low-energy electron flooding. The primary ion dose density is maintained below 10¹² ions·cm⁻² to ensure a static SIMS condition. The mass resolution is higher than 7,000 at m/z of less than 500 in both the positive and negative modes. Positive and negative ion spectra are obtained from the measurement area of each sample. Each spectrum is exported as an ASCII file.

Mass positions of the positive and negative ion spectra are internally calibrated using CH₃⁺, C₂H₃⁺, C₃H₅⁺ and C₅H₁₄NO⁺ peaks, and CH⁻, C₂H⁻, C₄H⁻ and C₁₈H₃₅O₂⁻ peaks, respectively. After the calibration, resulting mass accuracy is 10 ppm at m/z of less than 200 and about 15 ppm at m/z of over 200, in average.

3. Identification of the Ion Peak

The ‘TOFBAT’ program in the built-in IonSpec software from ION-TOF may be used to automatically identify peaks from a batch of TOF-SIMS spectra. Using TOFBAT, a batch job is set up in the batch-job-editor using the following macro functions in ‘Macro Toolbox’.

1) ‘For $A from 1 to n do’ in ‘System Macro’ to analyze multiple spectra using the ‘For-loop’; 2) ‘LoadSpec(<filename>)’ in ‘IonSpec Macro’ to load each spectrum and identify the peaks within the loop; and 3) ‘SaveSpecASCII(<filename>)’ to save the peaks from each spectra into an ASCII file within the loop.

The ‘Autosearch’ algorithm is used for peak detection. In the ‘SaveSpecASCII’ macro function, a mass range between 1 and 800 and an intensity threshold of 20 are set, and peaks having an intensity larger than 20 are detected within m/z=1 to 800. For each spectrum, the resulting ASCII file includes m/z, m/z ranges, and peak areas.

4. Generation of a Template for Peak Alignment

Using a list of peaks aligned from all spectra and sorted by their intensities, a template including non-redundant peaks as follows is generated. First, a peak with the largest intensity (rank 1) in the list is added to the template. Second, it is evaluated whether or not a peak with the second largest intensity (rank 2) in the list is redundant with the peak (rank 1) in the template. In the evaluation, width of the peak (rank 2) and width of the peak in the template (rank 1) are respectively calculated at ¾ of their intensities, and they are overlapped. Using non-zero overlap, it is concluded that the peak (rank 2) is redundant with the peak (rank 1) in the template, and thus this peak (rank 2) is skipped. The process moves to the next peak (rank 3) in the list, and then the redundancy evaluation process is repeated. On the other hand, if they are not overlapped, the peak (rank 2) is considered non-redundant with the peak (rank 1) in the template and added to the template. This procedure is repeated for all the peaks in the list. If there are k peaks in the template, a peak being evaluated its redundancy is compared with all the k reference peaks in the template.

5. Template-Based Alignment Method

Each peak identified from a spectrum is aligned with most properly overlapped reference peaks in the template. To identify the most properly overlapped peaks, 1) a mean difference (dᵢ) between the peak being aligned and reference peak i and 2) an overlap (vᵢ) between the widths of the peak and reference peak are calculated first at ¾ of their intensities. Then, their ratio dᵢ/vᵢ is calculated. Each peak is aligned with its most properly overlapped reference peak having the smallest ratio among all the reference peaks. This process is repeated for the peaks identified from each spectrum.

Hereinafter, a result of analysis of TOFSIMS-P according to the present invention will be described in detail.

1. TOF-SIMS Analysis

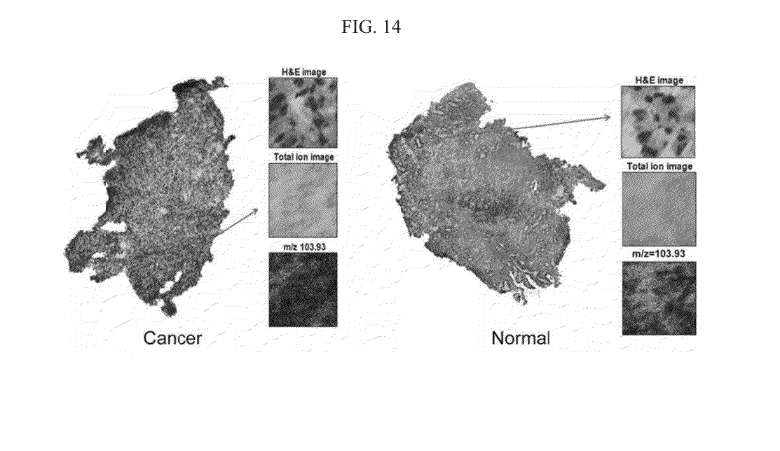

FIG. 14 is a view showing a TOF-SIMS analysis according to an embodiment of the present invention.

43 TOF-SIMS datasets are generated from seven gastric cancer tissues and eight normal tissues obtained from patients and volunteers undergoing endoscopic biopsy. For each tissue sample, a serial sectioning is performed at a thickness of 10 μm. One section is used for H&E staining to identify multiple areas that are enriched with normal epithelial or cancer cells. Corresponding areas in the other section are analyzed using TOF-SIMS in both the positive and negative modes. Two or three different areas in each tissue sample are analyzed to account for cellular heterogeneity which reflects various states of normal epithelial or tumor cells within the sample. A total of 43 sets of positive and negative ion spectra are generated from seven cancer samples and eight normal samples.

2. Peak Identification and Refinement

For the 43 sets of positive and negative spectra, a total of 87,138 ion peaks are identified using the TOFBAT program in the IonSpec software described above. Each peak is defined by m/z, an m/z range, and a peak area representing abundance of a corresponding ion. Close examination of these peaks, however, revealed that some of the peaks, especially the ones for low abundant ions, often become irregular due to the corruption of chemical noise, resulting in unreliable information of m/z and the areas. To remove these abnormally shaped peaks with the significant errors in such information, we applied Gaussian fitting to each peak identified by IonSpec.

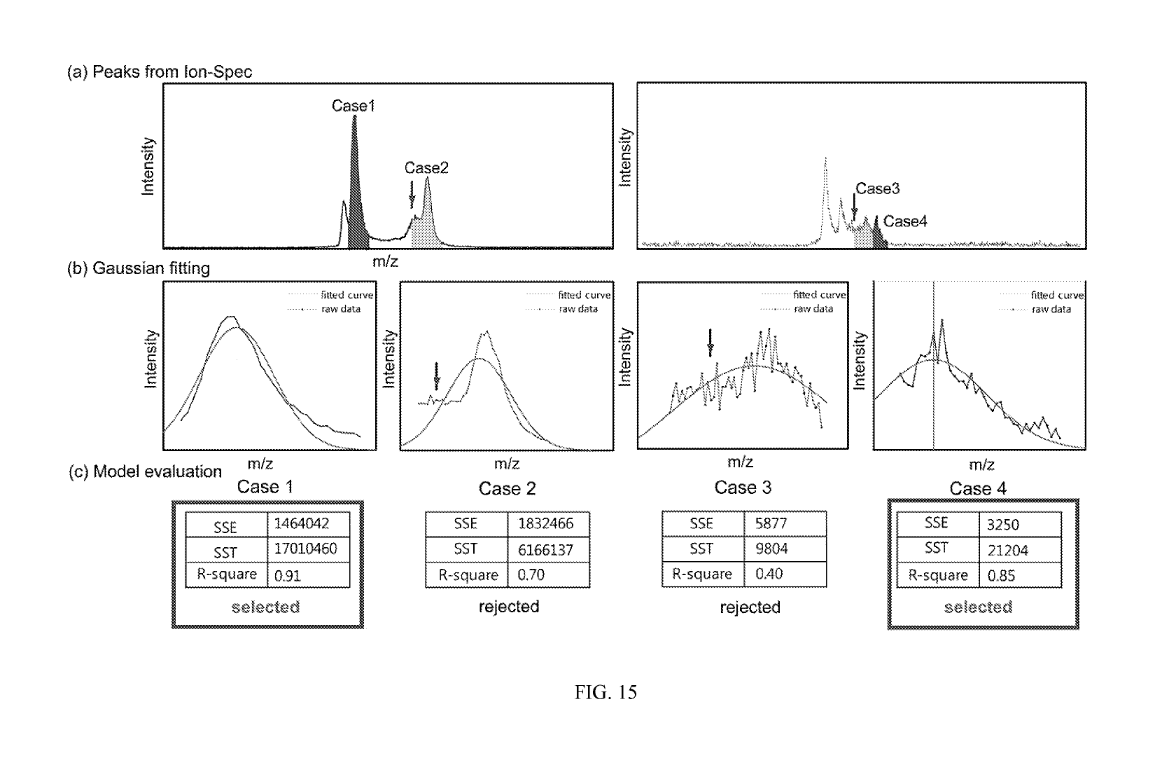

FIG. 15 is a view showing peak identification and improvement according to an embodiment of the present invention.

FIG. 15(a) shows four example peaks identified by IonSpec. After applying the Gaussian fitting to each peak, goodness-of-fit (R²) is evaluated. In cases 1 and 4, IonSpec correctly identifies the peaks. On the contrary, abnormal peaks are removed with R²<0.8. In cases 2 and 3, IonSpec incorrectly identifies two ion features as single peaks. After removing the abnormal peaks, 33% of the mean peak identified by IonSpec is selected for each spectrum in average for the further analyses.

3. Peak Alignment

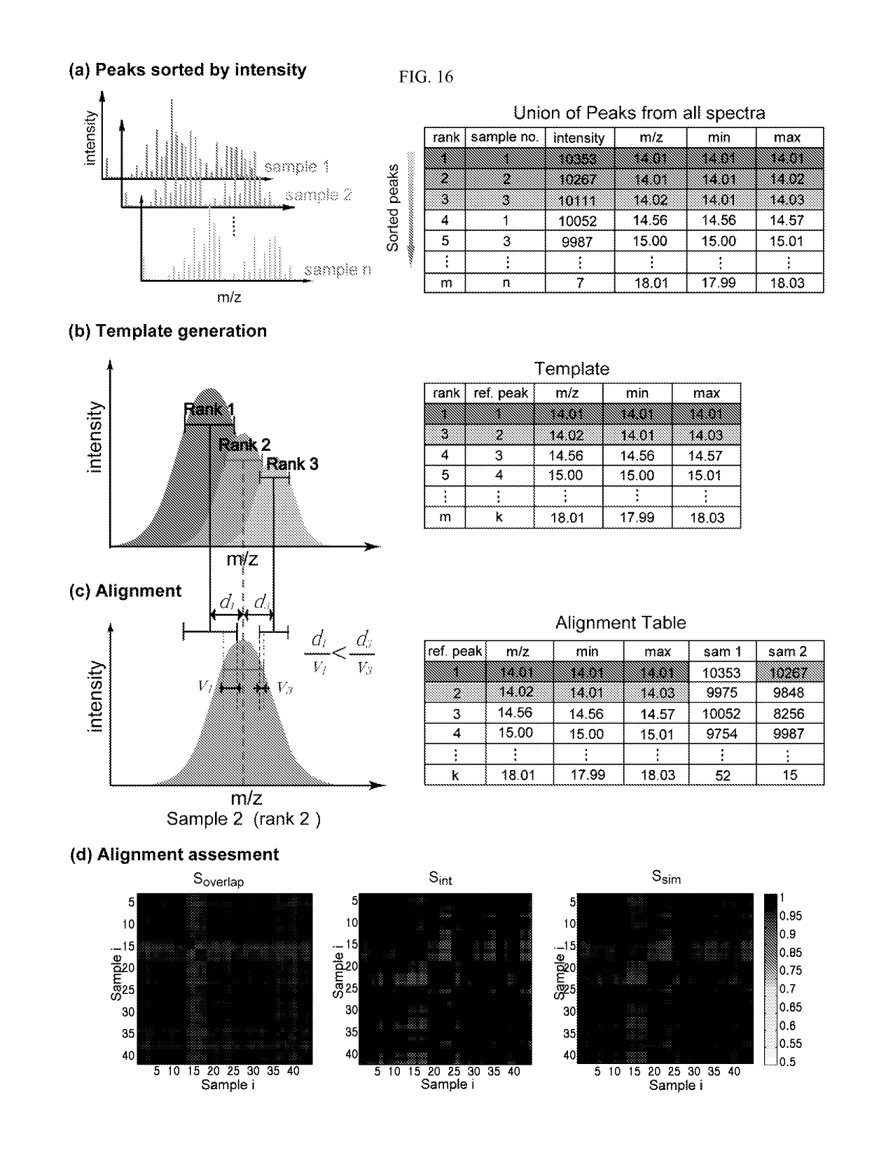

FIG. 16 is a view showing peak alignment according to an embodiment of the present invention.

In order to compare and analyze abundances of discriminatory ions in the peaks identified from multiple groups of samples, the same peaks in different samples should be combined, and this is referred to as peak alignment. In the present invention, a template-based alignment method including the four steps shown in FIG. 16 is developed.

First, the peaks aligned from all the samples are sorted by the intensity in the descending manner, and merged and classified by their intensities (FIG. 16(a)). Second, a template is generated to be used as a reference for aligning the peaks from all the samples. Moving down from the peak having the largest intensity in the list of FIG. 16(a), only non-redundant peaks are added to the template while redundant ones are removed (FIG. 16(b)). For the peaks identified from the 43 spectra, the resulting template is constructed to have 705 positive and 581 negative non-redundant ion peaks. Third, the peaks identified from each spectrum are aligned to their most properly overlapped reference peaks in the template (FIG. 16(c)). After the alignment of both positive and negative ion peaks, intensities of the positive and negative ion peaks are normalized using the quantile normalization method. Among the peaks in the template, peaks detected in more than 15 cancer samples and 18 normal samples are selected to ensure statistical reliability in the following analyses. For the positive and negative ion peaks, 233 positive and 225 negative ion peaks are selected, respectively. Fourth, performance of the alignment is assessed by evaluating similarities of all possible pairs of the 43 datasets (FIG. 16(d)). For each pair of the datasets, evaluated are the number of peaks generally detected in the two samples (Sₒᵥₑᵣₗₐₚ), correlation of peak intensities (Sᵢₙₜ), and their product as a combined similarity measure (Sₛᵢₘ). In FIG. 2(d), a high similarity score (Sₛᵢₘ>0.9) indicates that the peaks aligned from different samples are successfully aligned, considering that a majority of the peaks are not likely to be changed in their abundances across the samples.

4. Selection of Discriminatory Ions

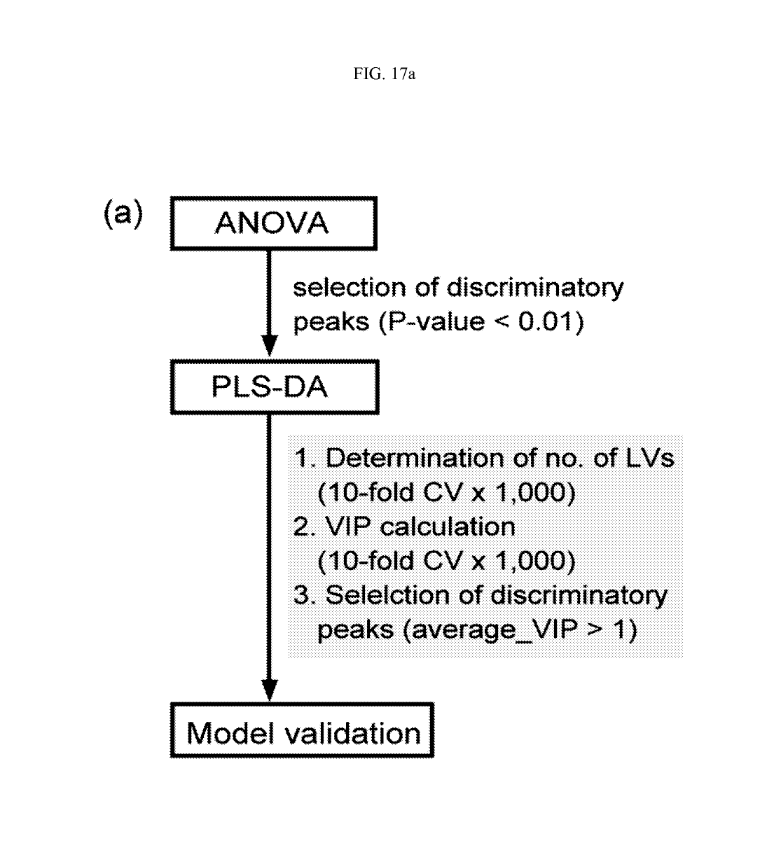

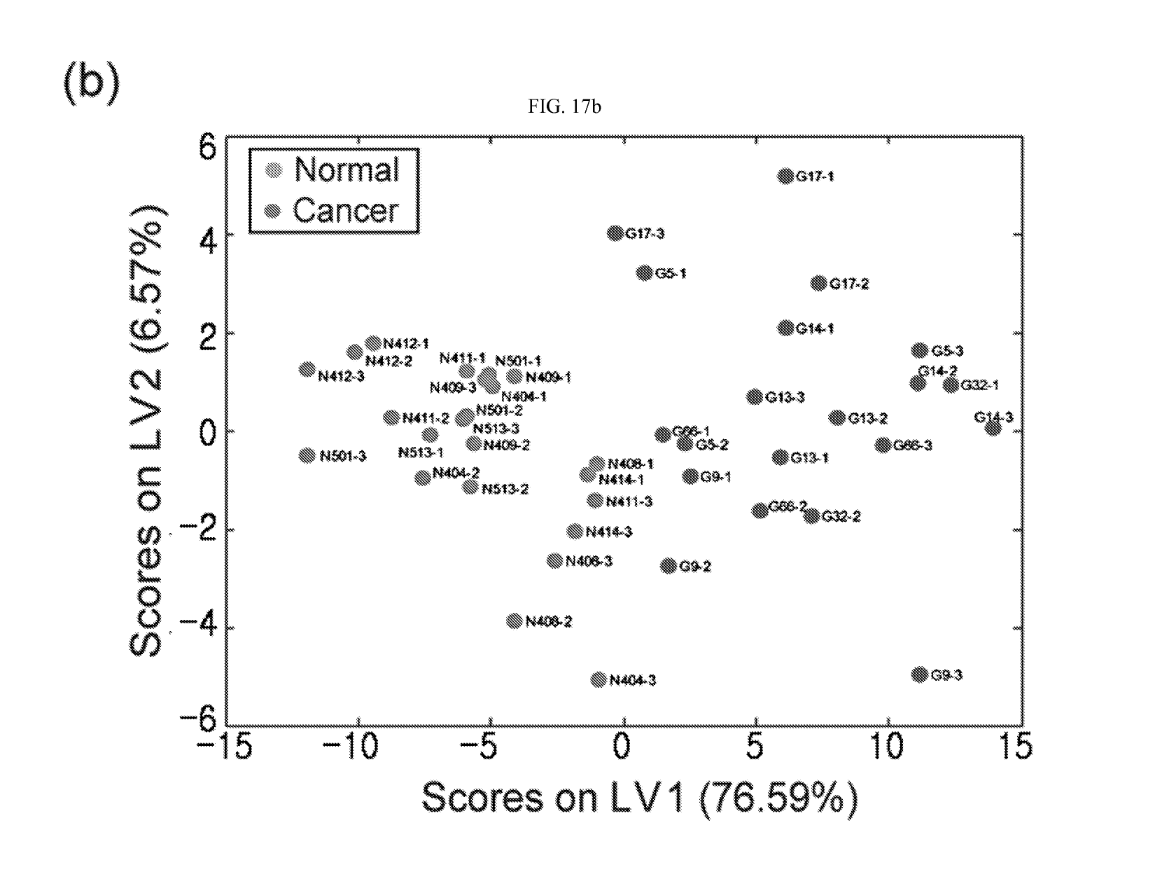

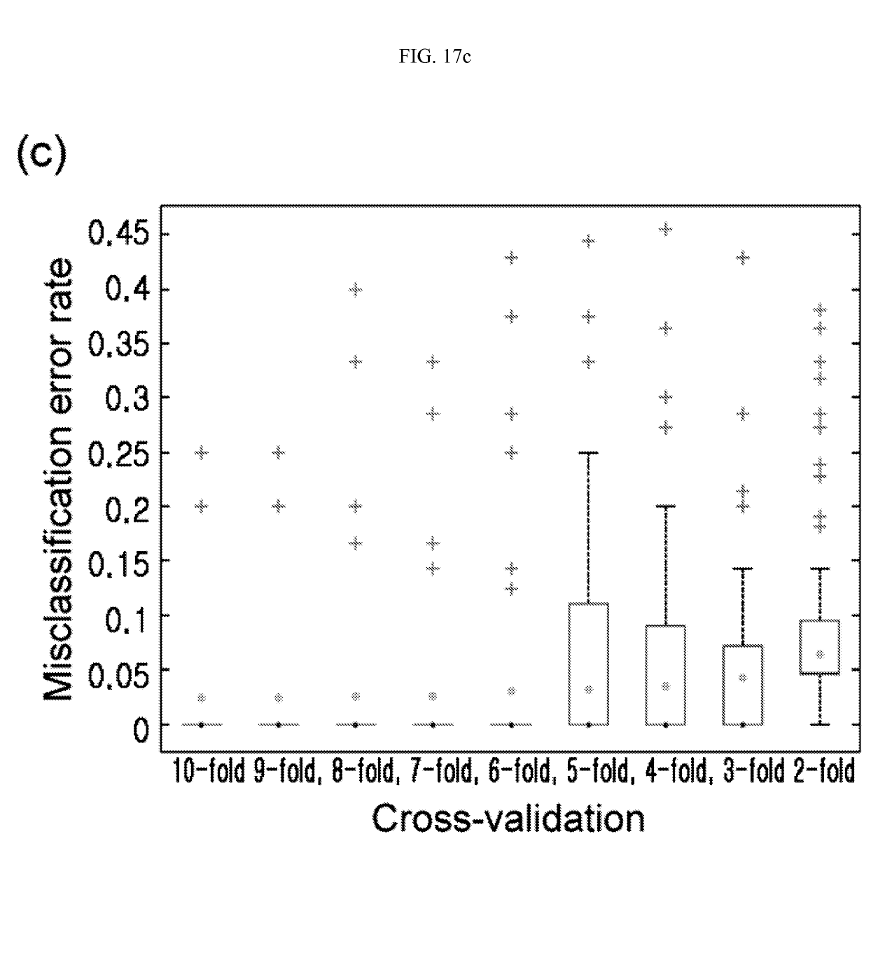

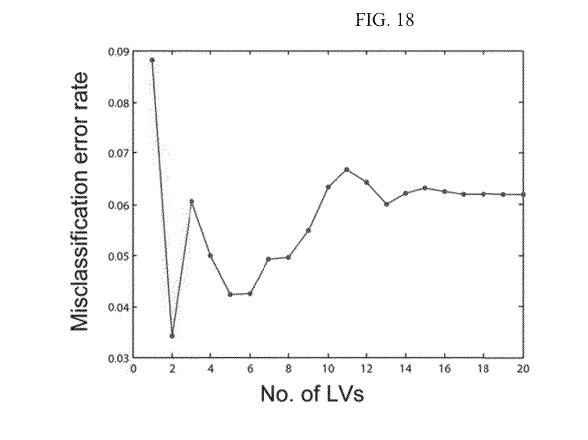

FIG. 17 is a view showing integrative selection of discriminatory ions according to an embodiment of the present invention, and FIG. 18 is a view showing determination of the number of PLS-LVs according to an embodiment of the present invention.

Ion peaks referred to as discriminatory ions are identified. Abundances of the ion peaks are different in gastric cancer and normal tissues. An ANOVA test is performed for all the aligned peaks, and 213 ion peaks with a p-value less than 0.01 is selected (FIG. 17(a)). The ANOVA test evaluates significance of individual peaks that can independently separate cancer tissues from normal ones. However, the significance should be evaluated based on collective contribution of the individual peaks to the separation. In order to evaluate the collective contribution, a multivariate classification analysis PLS-DA is applied to the intensities of the 213 peaks selected in the ANOVA test. For unbiased PLS-DA, 10-fold CVs is performed 1000 times. The CV experiments are repeated while increasing the number of PLS LVs, which reveals that two PLS LVs result in the smallest misclassification error rate. Using the two PLS LVs, the CVs is performed 1000 times again, and a mean of ‘variable importance in projection (VIP)’ of the peaks is calculated. The largest VIP value indicates that a corresponding peak has the highest collective contribution to the separation of cancer and normal tissues. The final set of the 66 discriminatory peaks is selected as the peaks with a mean of VIP>1 (FIG. 17(a)).

Interestingly, 63 discriminatory peaks out of 66 peaks are increased in their abundances in the cancer samples. FIG. 17(b) shows that the PLS-DA model constructed with the 66 discriminatory peaks can successfully discriminate gastric cancer samples from normal ones using the first two LV scores, resulting in the mean misclassification error rate of 0.02. Furthermore, robustness of performance of PLS-DA is evaluated using the 66 ion peaks against the variation in the size of the training set occurred by performing the incremental-fold CVs. FIG. 17(c) shows that the mean misclassification error rate is as small as six-fold CVs and increases together with its variance. However, the mean error rate is below 0.065 from the two-fold CVs, indicating that the 66 peaks show robust classification power even for samples of a considerably small size.

5. Identification of Discriminatory Metabolites and their Associated Metabolic Pathways

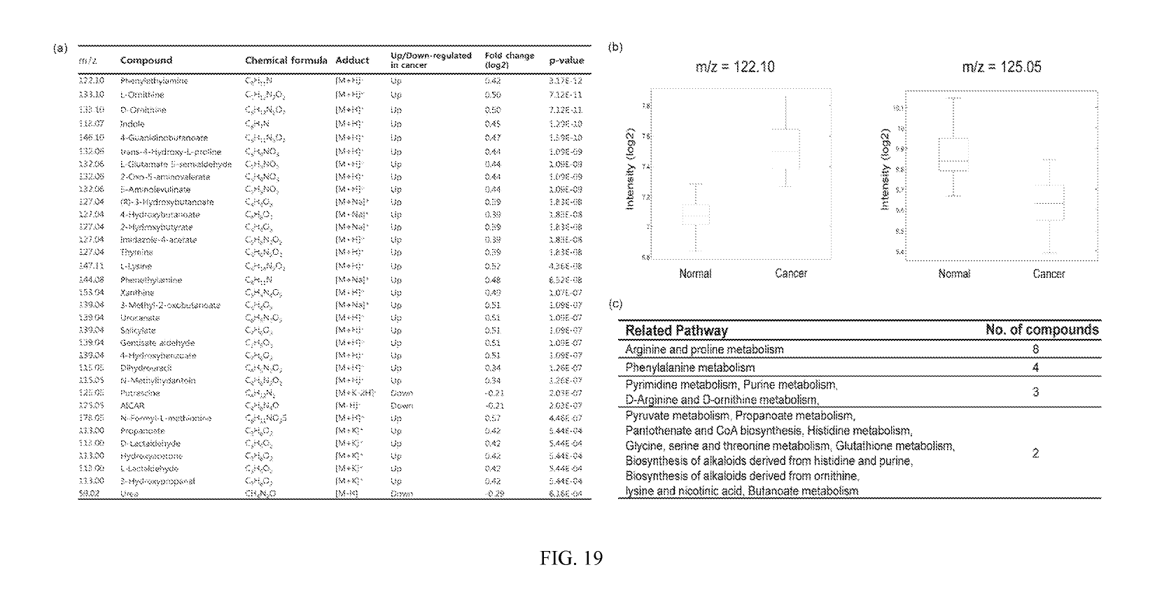

FIG. 19 is a view showing discriminatory peaks and pathways according to an embodiment of the present invention.

Metabolic ions for the 66 discriminatory peaks are identified by a search in the Human Metabolome Database (HMDB) using their m/z values having 25 of the mass tolerance of 0.1 Da. At this point, 33 m/z pairs shown in Table 1 can be used for the metabolic ions for the 66 discriminatory peaks searched from the gastric cancer.

TABLE 1

| | | Up/Down- | | | |
|---|---|---|---|---|---|
| | | Regulation | Chemical | | |
| Polarity | m/z | in cancer | formula | Adduct | Compound |
| Positive | 113.00 | Up | C3H6O2 | M+K [1+] | Hydroxyacetone |
| ion | | | C3H6O2 | M+K [1+] | L-Lactaldehyde |
| | | | C3H6O2 | M+K [1+] | Propanoate |
| | | | C3H6O2 | M+K [1+] | D-Lactaldehyde |
| | | | C3H6O2 | M+K [1+] | 3-Hydroxypropanal |
| | 115.05 | Up | C4H6N2O2 | M+H [1+] | Dihydrouracil |
| | | | C4H6N2O2 | M+H [1+] | N-Methylhydantoin |
| | 118.07 | Up | C8H7N | M+H [1+] | Indole |
| | 112.10 | Up | C8H11N | M+H [1+] | Phenylethyamine |
| | 127.04 | Up | C4H8O3 | M+Na [1+] | (R)-3-Hydroxybutanoate |
| | | | C4H8O3 | M+Na [1+] | 4-Hydroxybutanoate |
| | | | C4H8O3 | M+Na [1+] | 2-Hydroxybutyrate |
| | | | C5H6N2O2 | M+H [1+] | Imidazole-4-acetate |
| | | | C5H6N2O2 | M+H [1+] | Thymine |
| | 132.06 | Up | C5H9NO3 | M+H [1+] | trans-4-Hydroxy-L-proline |
| | | | C5H9NO3 | M+H [1+] | L-Glutamate-5- |
| | | | | | semialdehyde |
| | | | C5H9NO3 | M+H [1+] | 2-Oxo-5-aminovalerate |
| | | | C5H9NO3 | M+H [1+] | 5-Aminolevulinate |
| | 133.10 | Up | C5H12N2O2 | M+H [1+] | L-Ornithine |
| | | | C5H12N2O2 | M+H [1+] | D-Ornithine |
| | 139.04 | Up | C5H8O3 | M+Na [1+] | 3-Methyl-2-oxobutannoate |
| | | | C7H6O3 | M+H [1+] | Gentisate aldehyde |
| | | | C7H6O3 | M+H [1+] | Salicylate |
| | | | C7H6O3 | M+H [1+] | 4-Hydroxybenzonate |
| | | | C6H6N2O2 | M+H [1+] | Urocanate |
| | 144.08 | Up | C8H11N | M+Na [1+] | Phenylethylamine |
| | 146.10 | Up | C5H11N3O2 | M+H [1+] | 4-Guanidinobutanoate |
| | 147.11 | Up | C6H14N2O2 | M+H [1+] | L-Lysine |
| | 153.04 | Up | C5H4N4O2 | M+H [1+] | Xanthine |
| | 178.05 | Up | C6H11NO3S | M+H [1+] | N-Formyl-L-methionine |
| Negative | 59.02 | Down | CH4N2O | M−H [1−] | Urea |
| ion | 125.05 | Down | C5H6N4O | M−H [1−] | AlCAR |
| | | | C4H12N2 | M+k−2H [1−] | Putrescine |

25 peaks among the 66 peaks are assigned to 73 metabolites by the database search. According to the ‘KEGG Compound’ database, 32 metabolites other than the 73 metabolites have metabolic pathway information (FIG. 19(a)). FIG. 19(b) shows two example ions respectively up- and down-regulated in the cancer samples in comparison to normal examples. Using the pathway information, metabolic pathways containing metabolites of Arginine and proline, phenylalanine, pyrimidine and purine, D-arginine and D-ornithine, pyruvate, butanoate, propanoate, and histidine metabolisms are identified.

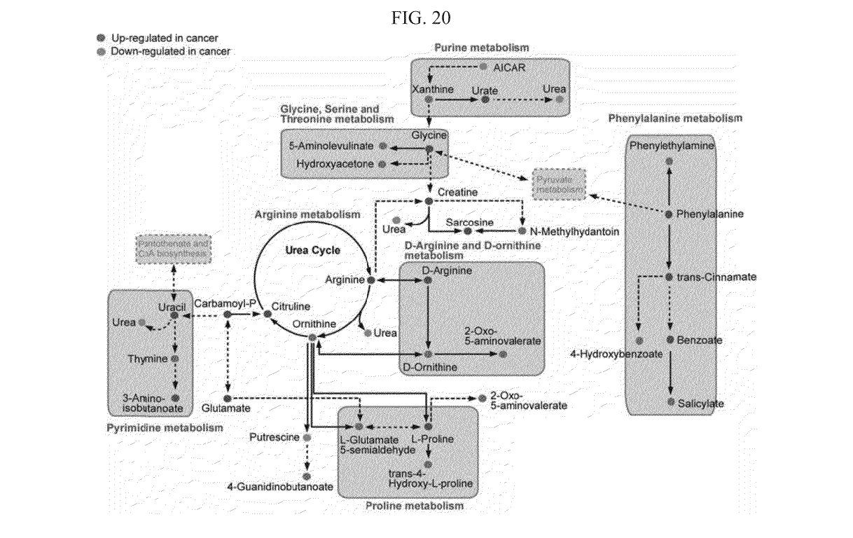

FIG. 20 is a view showing a network according to an embodiment of the present invention.

Among these pathways, FIG. 20 shows that amino acid and nucleotide metabolic pathways are closely related to each other and their activities increase in the gastric cancer. The metabolic network reveals two kinds of increase metabolic fluxes: 1) Ornithine→L-Glutamate 5-semialdehyde→trans-4-Hydroxy-L-proline (arginine and proline metabolism) and 2) Phenylalanine→Phenylethylamine, Salicylate, or 4-Hydroxybenzoate (Phenylalanine metabolism). The arginine and proline metbaolic pathway includes four ions of m/z=115.04 (N-Methylhydantoin), 132.06 (trans-4-Hydroxy-L-proline, L-Glutamate 5-semialdehyde, and 2-Oxo-5-aminovalerate), 133.10 (L-Ornithine), and 146.10 (4-Guanidinobutanoate). The phenylalanine metabolic pathway includes three ions of m/z=122.10 (Phenylethylamine), 139.04 (Salicylate, and 4-Hydroxybenzoate), and 144.08 (Phenylethylamine). It is shown that the arginine metabolism indirectly affects activities of tumor-associated immune cells, as well as directly affecting growth and survival of tumors. In addition, tumor-infiltrating regulatory dendritic cells are reported to suppress T-cell proliferation, compared with arginine metabolism. Moreover, treatment of modulators of the arginine metabolism, such as N(G)-nitro-L-arginine methyl ester and sildenafil, may modify endogenous tumor-specific immune responses and restrain growth of the tumors. Furthermore, ornithine, one of the products of L-arginine, and a precursor of polyamine via the action of ornithine decarboxylase can be used as a molecular metric for diagnosing the tumors. These previous findings support validity of a subset of the identified discriminatory ions, suggesting their potential use as molecular metrics for diagnosis of gastric cancers. On the other hand, many ions could not be identified by searching the HMDB due to the lack of information on small secondary metabolites generated during the TOF-SIMS analysis. Some of these ions may be provided as novel molecular metrics for diagnosing gastric cancers.

Currently, there is no efficient method for analyzing TOF-SIMS data generated from a large number of samples. Several tools, including IonSpec, TOFPak, and software for multivariate statistical analyses, have been introduced to analyze the TOF-SIMS data. However, they have some limitations in comparing and analyzing data of samples of a considerably large size. The present invention has developed a computational framework capable of automatically performing an analysis needed for the comparative analysis. Application of the framework to the 43 TOF-SIMS spectra obtained from gastric cancer and normal tissues results in 66 discriminatory ions. Some of the ions are involved in amino acid metabolism. Association of the increased metabolism in the gastric cancer has been previously reported. In conclusion, the results support the usefulness of the tool proposed for effective analysis of large-scale TOF-SIMS data. Therefore, the tool of the present invention may serve as a useful means in the broad spectrum field including extensive analysis of large-scale metabolic or lipidomic data.

Meanwhile, the embodiments of the present invention described above can be created as a program that can be executed in a computer and may be implemented in a general-purpose digital computer which operates the program using a computer readable recording medium. The computer readable recording medium includes a storage medium such as a magnetic storage medium (e.g., ROM, floppy disk, hard disk or the like) or an optical readable medium (e.g., CD-ROM, DVD or the like).

While the web-based platform for analyzing large-scale TOF-SIMS data and a method thereof according to the present invention have been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A web-based platform for analyzing large-scale TOF-SIMS data, the platform comprising:
a communication unit for providing a connected user terminal with a web page and receiving a file for analyzing the TOF-SIMS data from the user terminal via the provided web page;
a processing unit for analyzing the TOF-SIMS data using the received file and providing the user terminal with information created based on a result of the analysis via the communication unit; and
a storage unit for storing the information created based on the result of the analysis.

2. The platform according to claim 1, wherein the file includes at least any one of an IonSpec result file containing a peak list and a raw spectra file containing positive and negative spectra.

3. The platform according to claim 2, wherein the processing unit analyzes the TOF-SIMS data using the IonSpec result file and the raw spectra file.

4. The platform according to claim 2, wherein the processing unit creates at least one of an alignment table, a discriminatory peak summary table, a PLS-DA model, a cross-validation of the model, identification of discriminatory ions, and a result of pathway analysis of the discriminatory ions, as a result of the analysis.

5. The platform according to claim 4, wherein metabolic ions for 66 discriminatory peaks searched from a gastric cancer are identified by a search in a HMDB using an m/z value having a mass tolerance of 0.1 Da.

6. The platform according to claim 5, wherein 33 m/z pairs shown in a following table are used for the metabolic ions for the 66 discriminatory peaks searched from the gastric cancer.

| | | Up/Down- | | | |
|---|---|---|---|---|---|
| | | Regulation | Chemical | | |
| Polarity | m/z | in cancer | formula | Adduct | Compound |
| Positive | 113.00 | Up | C3H6O2 | M+K [1+] | Hydroxyacetone |
| ion | | | C3H6O2 | M+K [1+] | L-Lactaldehyde |
| | | | C3H6O2 | M+K [1+] | Propanoate |
| | | | C3H6O2 | M+K [1+] | D-Lactaldehyde |
| | | | C3H6O2 | M+K [1+] | 3-Hydroxypropanal |
| | 115.05 | Up | C4H6N2O2 | M+H [1+] | Dihydrouracil |
| | | | C4H6N2O2 | M+H [1+] | N-Methylhydantoin |
| | 118.07 | Up | C8H7N | M+H [1+] | Indole |
| | 112.10 | Up | C8H11N | M+H [1+] | Phenylethyamine |
| | 127.04 | Up | C4H8O3 | M+Na [1+] | (R)-3-Hydroxybutanoate |
| | | | C4H8O3 | M+Na [1+] | 4-Hydroxybutanoate |
| | | | C4H8O3 | M+Na [1+] | 2-Hydroxybutyrate |
| | | | C5H6N2O2 | M+H [1+] | Imidazole-4-acetate |
| | | | C5H6N2O2 | M+H [1+] | Thymine |
| | 132.06 | Up | C5H9NO3 | M+H [1+] | trans-4-Hydroxy-L-proline |
| | | | C5H9NO3 | M+H [1+] | L-Glutamate-5- |
| | | | | | semialdehyde |
| | | | C5H9NO3 | M+H [1+] | 2-Oxo-5-aminovalerate |
| | | | C5H9NO3 | M+H [1+] | 5-Aminolevulinate |
| | 133.10 | Up | C5H12N2O2 | M+H [1+] | L-Ornithine |
| | | | C5H12N2O2 | M+H [1+] | D-Ornithine |
| | 139.04 | Up | C5H8O3 | M+Na [1+] | 3-Methyl-2-oxobutannoate |
| | | | C7H6O3 | M+H [1+] | Gentisate aldehyde |
| | | | C7H6O3 | M+H [1+] | Salicylate |
| | | | C7H6O3 | M+H [1+] | 4-Hydroxybenzonate |
| | | | C6H6N2O2 | M+H [1+] | Urocanate |
| | 144.08 | Up | C8H11N | M+Na [1+] | Phenylethylamine |
| | 146.10 | Up | C5H11N3O2 | M+H [1+] | 4-Guanidinobutanoate |
| | 147.11 | Up | C6H14N2O2 | M+H [1+] | L-Lysine |
| | 153.04 | Up | C5H4N4O2 | M+H [1+] | Xanthine |
| | 178.05 | Up | C6H11NO3S | M+H [1+] | N-Formyl-L-methionine |
| Negative | 59.02 | Down | CH4N2O | M−H [1−] | Urea |
| ion | 125.05 | Down | C5H6N4O | M−H [1−] | AlCAR |
| | | | C4H12N2 | M+k−2H [1−] | Putrescine |

7. The platform according to claim 5, wherein 25 discriminatory peaks among the 66 discriminatory peaks are assigned to 73 metabolites by the database search.

8. The platform according to claim 2, wherein the processing unit provides the user terminal with the information created based on the result of the analysis via the web page.

9. The platform according to claim 2, wherein the processing unit provides the user terminal with the information created based on the result of the analysis via a message or an e-mail, and the message or the e-mail contains a link to an analysis result page.

10. A method of analyzing large-scale TOF-SIMS data, the method comprising the steps of:
(a) providing a connected user terminal with a web page and receiving a file for analyzing the TOF-SIMS data from the user terminal via the provided web page;
(b) analyzing the TOF-SIMS data using the received file; and
(c) providing the user terminal with information created based on a result of the analysis.

11. The method according to claim 10, wherein the file includes at least any one of an IonSpec result file containing a peak list and a raw spectra file containing positive and negative spectra.

12. The method according to claim 11, wherein step (b) analyzes the TOF-SIMS data using the IonSpec result file and the raw spectra file.

13. The method according to claim 11, wherein step (c) creates at least one of an alignment table, a discriminatory peak summary table, a PLS-DA model, a cross-validation of the model, identification of discriminatory ions, and a result of pathway analysis of the discriminatory ions, as a result of the analysis.

14. The method according to claim 13, wherein metabolic ions for 66 discriminatory peaks searched from a gastric cancer are identified by a search in a HMDB using an m/z value having a mass tolerance of 0.1 Da.

15. The method according to claim 14, wherein 33 m/z pairs shown in a following table are used for the metabolic ions for the 66 discriminatory peaks searched from the gastric cancer.

| | | Up/Down- | | | |
|---|---|---|---|---|---|
| | | Regulation | Chemical | | |
| Polarity | m/z | formula | in cancer | Adduct | Compound |
| Positive | 113.00 | Up | C3H6O2 | M+K [1+] | Hydroxyacetone |
| ion | | | C3H6O2 | M+K [1+] | L-Lactaldehyde |
| | | | C3H6O2 | M+K [1+] | Propanoate |
| | | | C3H6O2 | M+K [1+] | D-Lactaldehyde |
| | | | C3H6O2 | M+K [1+] | 3-Hydroxypropanal |
| | 115.05 | Up | C4H6N2O2 | M+H [1+] | Dihydrouracil |
| | | | C4H6N2O2 | M+H [1+] | N-Methylhydantoin |
| | 118.07 | Up | C8H7N | M+H [1+] | Indole |
| | 112.10 | Up | C8H11N | M+H [1+] | Phenylethyamine |
| | 127.04 | Up | C4H8O3 | M+Na [1+] | (R)-3-Hydroxybutanoate |
| | | | C4H8O3 | M+Na [1+] | 4-Hydroxybutanoate |
| | | | C4H8O3 | M+Na [1+] | 2-Hydroxybutyrate |
| | | | C5H6N2O2 | M+H [1+] | Imidazole-4-acetate |
| | | | C5H6N2O2 | M+H [1+] | Thymine |
| | 132.06 | Up | C5H9NO3 | M+H [1+] | trans-4-Hydroxy-L-proline |
| | | | C5H9NO3 | M+H [1+] | L-Glutamate-5- |
| | | | | | semialdehyde |
| | | | C5H9NO3 | M+H [1+] | 2-Oxo-5-aminovalerate |
| | | | C5H9NO3 | M+H [1+] | 5-Aminolevulinate |
| | 133.10 | Up | C5H12N2O2 | M+H [1+] | L-Ornithine |
| | | | C5H12N2O2 | M+H [1+] | D-Ornithine |
| | 139.04 | Up | C5H8O3 | M+Na [1+] | 3-Methyl-2-oxobutannoate |
| | | | C7H6O3 | M+H [1+] | Gentisate aldehyde |
| | | | C7H6O3 | M+H [1+] | Salicylate |
| | | | C7H6O3 | M+H [1+] | 4-Hydroxybenzonate |
| | | | C6H6N2O2 | M+H [1+] | Urocanate |
| | 144.08 | Up | C8H11N | M+Na [1+] | Phenylethylamine |
| | 146.10 | Up | C5H11N3O2 | M+H [1+] | 4-Guanidinobutanoate |
| | 147.11 | Up | C6H14N2O2 | M+H [1+] | L-Lysine |
| | 153.04 | Up | C5H4N4O2 | M+H [1+] | Xanthine |
| | 178.05 | Up | C6H11NO3S | M+H [1+] | N-Formyl-L-methionine |
| Negative | 59.02 | Down | CH4N2O | M−H [1−] | Urea |
| ion | 125.05 | Down | C5H6N4O | M−H [1−] | AlCAR |
| | | | C4H12N2 | M+k−2H [1−] | Putrescine |

16. The method according to claim 14, wherein 25 discriminatory peaks among the 66 discriminatory peaks are assigned to 73 metabolites by the database search.

17. The method according to claim 11, wherein step (c) provides the user terminal with the information created based on the result of the analysis via the web page.

18. The method according to claim 11, wherein step (c) provides the user terminal with the information created based on the result of the analysis via a message or an e-mail, and the message or the e-mail contains a link to an analysis result page.
